(19) United States
(12) Patent Application Publication
(10) Pub. No.: US 2004/0005717 A1
(43) Pub. Date: Jan. 8, 2004

(54) Methods for non-invasive measurement of blood electrolyte concentration

(75) Inventor: Babs R. Soller, Northboro, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: UMASS/WORCESTER, Worcester, MA (US)

(21) Appl. No.: 10/457,873

(22) Filed: Jun. 10, 2003

Related U.S. Application Data
(60) Provisional application No. 60/387,804, filed on Jun. 11, 2002.

(51) Int. Cl. G01N 21/00

(52) U.S. Cl. 436/164; 600/322

(57) ABSTRACT

The present invention provides methods for non-invasive spectroscopic measurement of the concentration of an electrolyte, such as, sodium, potassium, or calcium ion, in a subject's blood. In one embodiment of a method according to the invention, calibration spectra are obtained from a group of subjects having variable blood electrolyte concentrations, and simultaneously blood is drawn from these subjects for measuring reference electrolyte concentrations. Standard multivariate calibration methods are employed to develop one or more calibration equations, based on the calibration spectra and the reference measurements. These calibration equations can be employed to analyze spectra obtained from a new subject to non-invasively determine the concentration of the electrolyte of interest.

### RELATED APPLICATIONS

The present application claims priority to a provisional application entitled “Methods for Non-invasive Measurement of Blood Electrolyte Concentration” filed on Jun. 11, 2002 and having a Serial No. 60/387804.

### BACKGROUND

The present invention relates generally to methods for non-invasive measurement of an analyte in a subject' blood, and more particularly, to spectroscopic methods for non-invasive measurement of an electrolyte in a subject's blood.

Blood chemistry parameters, such as, oxygen and carbon dioxide partial pressure, pH and electrolyte (Na⁺, K⁺ and Ca²⁺) concentration provide some of the most important diagnostic tools for evaluation and treatment of critically ill patients. The concentrations of blood electrolytes can be affected by a variety of disorders that produce electrolyte abnormalities. Further, the administration of intravenous fluids requires periodic assessment of electrolyte concentrations. Hence, a knowledge of the concentrations of a subject's electrolytes is of particular importance. For example, measurement of sodium levels can provide important clues for diagnosing renal problems and in treating patients who lose fluid through vomiting, diarrhea, or sweat. Knowledge of potassium levels is important in the treatment of cardiac patients. Derangements in potassium are also observed with skeletal muscle disorder and conditions that result in variation in intracellular pH. Further, knowledge of calcium concentrations is important in monitoring treatment of patients who receive intravenous fluids, or receive CaCl₂ for cardiac problems, as well as investigating defects in parathyroid and renal functions.

Measurements of blood electrolytes are traditionally accomplished by removing a blood sample from the patient. There is a small risk to the patient if only one sample is taken for analysis. However, in many situations, multiple blood samples are required to track the course of illness and chart response to therapy. Many patients, particularly children, can not afford to lose significant blood volume for testing, thus reducing the number of samples that can be acquired. In addition, placement of a catheter for frequent blood draws carries the risk of infection and blood clots. Additionally, there are risks to the healthcare workers who collect and process the blood for laboratory tests. All healthcare workers who handle blood must worry about exposure to hepatitis and AIDS. Hence, non-invasive measurements of blood chemistry parameters would reduce risks to both patient and healthcare workers.

Thus, there exists considerable interest in systems and methods for non-invasively measuring blood and tissue chemistry. One such non-invasive technique, known as pulse oximetry, utilizes optical spectroscopy in the near infrared region of the electromagnetic spectrum, which passes through the skin, to measure arterial oxygen saturation (ratio of oxygenated to total hemoglobin), as a self normalizing measurement. The normalization helps account for light scattering as the probing beam passes through tissue and for the interferences from other absorbing species in the light path.

Measurement of absolute concentration of a blood analyte, for example, an electrolyte, poses additional challenges as a result of light scattering and interference from other absorbing and/or scattering species.

Accordingly, there exists a need for improved methods for non-invasively measuring the concentration of an analyte of interest in a subject's blood.

Further, there exists a need for methods that allow non-invasive measurement of an absolute concentration of a blood electrolyte.

### SUMMARY OF THE INVENTION

The present invention provides a method for non-invasive measurement of an electrolyte of interest in blood by initially obtaining a plurality of blood calibration spectra from a plurality of calibration subjects having varying blood concentrations of the electrolyte. These calibration spectra can be obtained by utilizing light having at least one wavelength component in a pre-defined wavelength range. For example, light having a wavelength in a range of about 475 nm to about 1000 nm, or in a range of 1000 nm to about 2000 nm can be employed to obtain the calibration spectra. Subsequently, reference concentration values are generated for the electrolyte by measuring the electrolyte concentration in each calibration subject's blood by utilizing any standard invasive measurement technique. The calibration spectra and the reference concentration values are then employed to derive one or more calibration equations for the electrolyte.

In a related aspect, in a method as described above, light having the same spectral characteristics as that utilized to obtain the calibration spectra is employed to obtain one or more spectra of the blood of a new subject, i.e., the blood spectra of a subject who is not a member of the calibration group. The newly obtained spectra are processed with the calibration equation to measure a concentration of the electrolyte in the new subject's blood.

The methods of the invention can be employed to measure the concentration of a variety of different ions in blood or other bodily fluids such as plasma, spinal fluid, saliva or urine. Such ions can include, but are not limited to, sodium ion, calcium ion, and potassium ion. For a given electrolyte, it may be advantageous to utilize light in a selected wavelength range in which variations in the concentration of the electrolyte can have a measurable effect on the obtained spectra. For example, in one embodiment, light having a wavelength in a range of about 475 nm to about 1000 nm is employed for measuring the concentration of sodium ion while light having a wavelength in a range of about 1000 nm to about 1900 nm is employed for measuring the concentration of potassium ion. In addition, light having a wavelength in a range of about 2000 nm to about 2585 nm can be utilized for calcium concentration measurements.

In another aspect, radiation in a wavelength range of about 470 nm to about 925 nm, in which oxyhemoglobin exhibits absorption while water exhibits little absorption, is employed to obtain concentrations of sodium, potassium, and/or calcium ions in a subject's blood in accordance with the teachings of the invention.

In further aspects, the invention provides a method for non-invasive measurement of concentration of an electrolyte of interest in blood that includes a step of collecting one or more spectra of one or more blood samples having variable electrolyte concentrations by utilizing light having at least one wavelength component in a selected wavelength range. In another step, the electrolyte concentration of each of the blood samples is measured by utilizing any standard invasive technique. Further, the collected spectra are augmented with one or more human variability factors. The human variability factors can be, for example, any of skin color, fat content, age or a disease condition. Subsequently, a calibration equation corresponding to the electrolyte is derived based on the augmented calibration spectra and the measured electrolyte concentrations.

In a related aspect, the calibration equation is derived by utilizing multivariate calibration, or chemometric, techniques. These techniques are based on statistical methods that permit isolation of relevant spectral components in the absence of exact knowledge of all of the interfering analytes present in complex chemical or biological systems. The derived calibration equation can be employed to non-invasively and spectroscopically measure the concentration of the electrolyte for which the calibration was performed. In particular, one or more spectra of a subject's blood can be obtained by utilizing light having substantially similar spectral characteristics as the light employed for calibration. These spectra are processed with the derived calibration equation to measure the electrolyte concentration.

Further understanding of the invention can be obtained by reference to the following experimental section.

### BRIEF DESCRIPTION OF THE DRAWINGS

FIG. 1 is a flow chart depicting various steps in an exemplary method according to the invention for non-invasively measuring a blood electrolyte concentration,

FIG. 2 is another flow chart depicting steps of another embodiment of the invention for non-invasively measuring blood electrolyte concentration,

FIGS. 3A-3C illustrate exemplary correlation spectra for sodium, potassium, and calcium ions, respectively, showing regions of the spectrum most correlated with electrolyte concentration,

FIG. 4 illustrates spectra of calibration samples utilized to develop calibration models for sodium, potassium, and calcium ions in a single solution,

FIG. 5A illustrates loading vectors that are most correlated with each ion for the full wavelength models developed from data set containing all three ions,

FIG. 5B illustrates enlarged version of the Na⁺ loading vector and its correlation with a water band,

FIGS. 6A-6C present a number of plots of actual ion concentration versus ion concentrations derived by utilizing NIR spectroscopy in accordance with the teachings of the invention for sodium, potassium, and calcium ions, respectively, utilizing absorbance selectively in the range of about 470-2200 nm.

FIG. 7A presents a graph illustrating concentration of Na⁺ ion, which is spectroscopically calculated according to the teachings of the invention by utilizing absorption data in a wavelength range of about 470 to 925 nm (hemoglobin absorption alone), plotted against reference blood electrolyte concentration for diluted whole blood containing varying concentrations of sodium, potassium, and calcium ions,

FIG. 7B presents a graph illustrating concentration of K⁺ ion, which is spectroscopically calculated according to the teachings of the invention by utilizing absorption data in a wavelength range of about 470 nm to 925 nm (hemoglobin absorption alone), plotted against reference blood electrolyte concentration for diluted whole blood containing varying concentrations of sodium, potassium, and calcium ions,

FIG. 7C presents a graph illustrating concentration of Ca²⁺ ion, which is spectroscopically calculated according to the teachings of the invention by utilizing absorption data in a wavelength range of about 470 nm to 925 nm (hemoglobin absorption alone), plotted against reference blood electrolyte concentration for diluted whole blood containing varying concentration of sodium, potassium, and calcium ions,

FIG. 8A illustrates a plurality of loading vectors for the sodium model, in a wavelength range of about 470 nm to 925 nm, in whole blood containing sodium, potassium, and calcium, and

FIG. 8B illustrates a plurality of loading vectors for the sodium model, in a wavelength range of about 470 nm to 925 nm, in lysed blood with only sodium.

### DETAILED DESCRIPTION

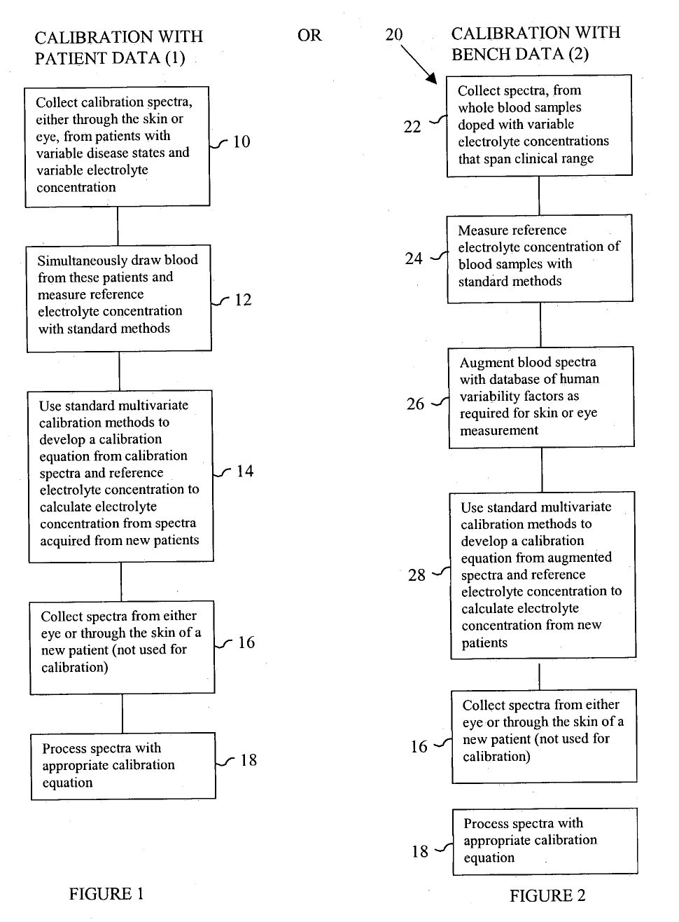

The present invention provides methods for non-invasive spectroscopic measurement of an analyte of interest, and more particularly, for non-invasive spectroscopic measurement of an electrolyte, such as, sodium ion, potassium ion, or calcium ion, in a subject's blood. In particular, with reference to FIG. 1, in an exemplary illustrative method of the invention, in an initial step 10, calibration spectra are obtained from a plurality of patients with variable disease states and variable electrolyte concentrations. These calibration spectra can be obtained, for example, transdermally, or alternatively, through the patient's eye, as discussed in more detail in the following experimental section.

In step 12, simultaneously with, or in close temporal proximity to, the step of obtaining the spectra, blood is drawn from the calibration patients to measure the concentrations of one or more electrolytes of interest present in the blood by utilizing standard techniques. These measured concentrations provide reference values that can be utilized together with the calibration spectra to develop calibration models for the analytes, as described in more detail below.

In step 14, a calibration model, including one or more calibration equations, for each electrolyte of interest, is developed based on the calibration spectra and the reference concentration measurements by utilizing, for example, multivariate calibration methods. The calibration methods can employ positive or negative correlations between the concentration of the electrolyte of interest and the elicited spectral response to generate the calibration equations. The calibration model can be utilized to analyze spectra obtained from a new patient, i.e., a patient that is not a member of the calibration group, to measure the concentration of the electrolyte in that patient's blood.

In some embodiments of the invention, partial least squares (PLS) techniques are utilized to derive the calibration equations. As known by those having ordinary skill in the art, PLS is a quantitative decomposition technique that performs decomposition on both spectral and concentration data simultaneously. PLS utilizes concentration information during the decomposition process to cause spectra containing high constituent concentrations to be weighted more heavily than those with low concentrations. Various PLS algorithms are known to those having ordinary skill in the art.

More particularly, in step 16, spectra are collected, for example, transdermally or through the eye, from a new patient, and in step 18, the collected spectra are processed by utilizing the generated calibration equations to measure the concentration of the electrolyte of interest.

The methods of the invention for deriving calibration equations corresponding to an analyte of interest are not limited to those described above. In particular, with reference to a flow chart 20 of FIG. 2, in another embodiment, in step 22, calibration spectra are obtained from whole blood samples doped with variable electrolyte concentrations that span a clinically relevant range. In step 24, the electrolyte concentrations of the samples are measured by utilizing standard techniques to generate a set of reference concentration values.

With continued reference to FIG. 2, in step 26, the blood spectra obtained from the whole blood samples are augmented with database of human variability factors, as needed. A database of human variability factors can be constructed by employing, for example, the methods described in co-pending U.S. patent application entitled “Correction of Spectra for Subject Diversity,” having Ser. No. 10/086,917, filed on Feb. 28, 2002, and herein incorporated by reference in its entirety.

For example, skin color factors can be calculated by utilizing a set of multi-ethnic subjects. These factors, which spectrally appear similar to melanin, can then be employed to add the spectral contribution from skin color to any set of spectra acquired from blood samples used to develop the calibration equation. These factors, which can be added in any proportion to simulate human spectra from many ethnic groups, can be used to generate an artificial set of transdermal spectra from which electrolyte calibration equations can be derived in accordance with the teachings of the invention.

Subsequently, in step 28, one or more calibration equations are derived for the electrolyte of interest based on the augmented spectra and the reference measurements of the electrolyte concentrations by utilizing, for example, multivariate calibration methods.

These calibration equations can then be employed to measure the concentration of the analyte in a new patient's blood by analyzing spectra obtained from the new patient in a similar manner as that discussed above in connection with the first embodiment. In particular, similar to the previous embodiment, in steps 16 and 18, spectra can be obtained from a new patient, to be processed by utilizing the derived calibration equations in order to obtain the concentration of the electrolyte of interest.

Further understanding of the invention can be obtained by reference to the following experimental section and the examples discussed therein.

Experimental

Blood was collected from healthy volunteers in vacutainer tubes containing dry Li-Heparin. A single subject's blood was utilized for each analyte. Fresh blood (˜30 ml) was collected each day and stored in the refrigerator until used for the experiment that day. No blood was stored for more than 7 hours. The experiments were designed to maintain PO₂, PCO₂, pH and hemoglobin concentrations constant and in the physiologic range. Each electrolyte was first studied separately, i.e., without varying the concentration of the other electrolytes, to determine the feasibility of measuring each ion in blood. In a second experiment, the concentrations of 3 electrolytes were varied simultaneously to determine if the concentration of each ion could be measured in the presence of varying concentration of the other cation species. Sodium was also examined in a study using lysed blood to investigate the effect of cell swelling on the calibration models.

Twenty-four solutions of whole blood were prepared to vary the sodium ion concentration between 100 and 180 mmol/L. 2 ml of whole blood was diluted with 2 ml of D5W (5% dextrose in water) to bring the concentration of sodium below the minimum level (for example, 100 mmol/L) and to maintain physiologic osmolarity. An appropriate amount of NaCl powder was dissolved in the solution to meet the target Na⁺ concentration. Three drops of contrafoam were added to the solution to prevent foaming and the solution was tonometered (Linear Tonometer, Inc., Model KGT ¾, Commack, N.Y.) at 37° C. for 8 minutes with a gas mixture containing 12% O₂, 6% CO₂, and the balance N₂.

Twenty-four solutions were prepared to vary the calcium ion concentration between 0.6 and 2.0 mmol/L. 2 ml of whole blood were diluted with 2 ml of 0.9% saline (NaCl). An appropriate amount of CaCl₂ powder was dissolved in the solution to meet the target Ca²⁺ concentration. These solutions were tonometered using the same procedure as that employed for the sodium solutions.

Finally, 24 solutions were prepared to vary the potassium ion concentration between 2.5-9.0 mmol/L. Two milliliters of whole blood was diluted with 2 ml 0.9% saline, KCl powder was weighed and dissolved and the solution tonometered using the same procedure as that utilized for Na⁺ and Ca²⁺ solutions.

In another series of experiments, the concentrations of Na⁺, K⁺, and Ca²⁺ were varied simultaneously over the same ranges as the previous experiment. The concentration of each sample was determined by uniform design to randomize the concentrations of each analyte over the course of the experiment. In these experiments, 2 ml of blood was diluted with 2 ml of D5W, and ammonium bicarbonate was added to help maintain the pH at normal levels. The blood was tonometered at the same conditions as above to bring the solution to physiologic levels of PO₂, PCO₂ and pH.

In the third experiment, lysed blood samples were prepared. Blood was collected from a healthy volunteer in 14 green vacutainers containing lithium heparin, and kept on ice. Each tube was sonicated (Biosonik sonicator) for 1 minute at a setting of 40, while kept cold in an ice bath. The tubes were spun down at 3000 rpms at 10° C. for 10 minutes, and the burgundy supernatant was removed and combined in a 50 cc conical tube. Lysed blood was stable and stored in the refrigerator for 3 days. Each 2 ml sample of lysed blood was diluted with 1 ml of D5W containing ammonium bicarbonate and an appropriate amount of NaCl was added to randomly vary the sodium concentration between 100 and 180 mmol/L. The samples were tonometered as above.

The blood was removed from the tonometer for measurement of electrolyte concentration, pH and blood gases and to fill the transmission cell in the spectrometer. A small sample was measured on either the I-Stat Portable Clinical Analyzer (Abbott Laboratories, Inc.) for the individual ion analysis or the Instrumentation Laboratories 1640 pH/Blood Gas/Electrolyte Analyzer for the mixed analyte and lysed blood experiments. The remaining portion was injected into the spectrometer cell. The spectrometer cell (pathlength=0.4 mm) was temperature controlled at 37°±2° C. with a circulating water bath. The spectra were acquired on a Nicolet Nexus 670 FTIR using 256 scans. The visible region (400-1162 nm) spectrum was acquired with a silicon detector, and the NIR region (833-2631 nm) spectrum was obtained with an InGaAs detector. The blood was removed from the spectrometer cell and was sent to a hospital laboratory for measurement of the mean corpuscular volume, the hemoglobin concentration and the hematocrit.

Absorption spectra were calculated using a reference collected from the blank cell just before the blood was introduced. Absorption spectra were analyzed in the PLS-IQ module of GRAMS32 v5 software distributed by Thermo Galactic Corp of Salem, N.H. All spectra were mean centered before performing a partial least-squares analysis. Cross-validation was utilized to determine an optimal number of PLS factors. The optimal number was selected to be the number that produced an F-test of the PRESS value less than 0.75. Concentration and spectral outliers were removed if the F-ratio was greater than 3.0. Cross-validated standard error of prediction (CVSEP) was used as an estimate of model accuracy and the relative error was calculated as CVSEP divided by the average analyte concentration.

Experimental Results and Discussion

### EXAMPLE 1

Individual Ion Experiments

In the first 3 experiments, each analyte concentration was varied separately while the other analytes and important physiologic parameters were controlled. In particular, pH, PCO₂, PO₂ and oxygen saturation were maintained at constant levels and at normal physiologic values by tonometering the sample with oxygen and carbon dioxide. There was good success in maintaining these respiratory and metabolic variables constant. However, the pH value, while in the physiologic range, was lower than normal. It was subsequently determined that 50% dilution of the blood resulted in a bicarbonate concentration that was too low to effectively buffer the solution. In the lysed sodium and aggregate ion experiments, ammonium bicarbonate was added to increase the buffer capacity and achieve normal pH values. Table I shows the concentration or values of these important parameters.

TABLE I
Concentration of controlled parameters in samples prepared for spectroscopic
analysis.

| | | | PCO₂ | PO₂ | Na⁺ | K⁺ | Ca²⁺ | HCO₃ | | Hgb | MCV |
|---|---|---|---|---|---|---|---|---|---|---|---|
| Experiment | | pH | mmHg | mmHG | mmol/L | mmol/L | mmol/L | mmol/L | % O₂Hgb | g/dl | fl |
| sodium ion—whole blood | mean | 7.090 | 42.9 | 88 | — | 3.0 | 0.61 | | | 7.2 | 102.5 |
| [Na⁺]: 100-180 mmol/L | std dev | 0.017 | 0.8 | 5 | — | 0.5 | 0.02 | | | 0.3 | 5.6 |
| | % var | 0.2 | 1.9 | 5.7 | — | 16.7 | 3.3 | | | 4.2 | 5.5 |
| potassium ion—whole | mean | 7.054 | 41.5 | 91 | 149 | — | 0.56 | | | 7.3 | 93.3 |
| blood | std dev | 0.010 | 1.0 | 4 | 2 | — | 0.01 | | | 0.3 | 0.8 |
| [K⁺]: 2.9-9.0 mmol/L | % var | 0.1 | 2.4 | 4.4 | 1.3 | — | 1.8 | | | 4.1 | 0.9 |
| calcium ion—whole blood | mean | 7.101 | 42.5 | 86 | 151 | 2.9 | — | | | 6.3 | 91.3 |
| [Ca²⁺]: 0.65-1.62 mmol/L | std dev | 0.014 | 1.0 | 4 | 2 | 0.3 | — | | | 0.2 | 0.6 |
| | % var | 0.2 | 2.4 | 4.7 | 1.3 | 10.3 | — | | | 3.2 | 0.7 |
| soidum ion—lysed blood | mean | 7.401 | 41.1 | 94 | — | 19.9 | 0.49 | 25.8 | 9.7 | 5.9 | N/A |
| [Na⁺]: 90-172 mmol/L | std dev | 0.036 | 0.6 | 16 | — | 0.9 | 0.03 | 2.2 | 0.4 | 0.1 | N/A |
| | % var | 0.5 | 1.4 | 17.3 | — | 4.6 | 6.8 | 8.5 | 0.4 | 2.2 | N/A |
| all 3 analytes—whole blood | mean | 7.377 | 40.8 | 85 | — | — | — | 24.2 | 95.0 | 6.2 | 106.3 |
| [Na⁺]: 83-178 mmol/L | std dev | 0.034 | 1.5 | 11 | — | — | — | 2.2 | 0.4 | 0.2 | 4.7 |
| [K⁺]: 3.7-13.2 mmol/L | % var | 0.5 | 3.8 | 13.1 | — | — | — | 8.9 | 0.4 | 3.2 | 4.5 |
| [Ca²⁺]: 0.55-2.56 mmol/L | | | | | | | | | | | |

% O₂Hgb: percent oxygenated hemoglobin;
Hgb: hemoglobin concentration;
Hct: hematocrit;
MCV: mean corpuscular volume

The concentration of sodium and calcium ions were constant when the remaining analyte was studied. However, there was some variation in the potassium ion concentration. This variation was likely due to a small amount of cell lysis and leakage of the high intracellular concentration of potassium into the serum.

The second sample preparation goal was to maintain the hemoglobin concentration constant and to assess the effects of cell swelling. The hemoglobin concentration was constant throughout the experiments and was, as expected, at 50% of the starting hemoglobin concentration. Mean corpuscular volume (MCV) is an actual measurement of the red cell size.

There was some variation in cell size during the sodium experiments, but little variation in cell size for the potassium and calcium experiments. There was strong correlation between sodium ion concentration and MCV (R²=0.92). Hence, sodium ion was studied in lysed blood to separate out the spectral effects of sodium from that of cell swelling. Neither potassium nor calcium was studied in lysed blood because there was no correlation between MCV and potassium (R²=0.05) or calcium (R²=0.06).

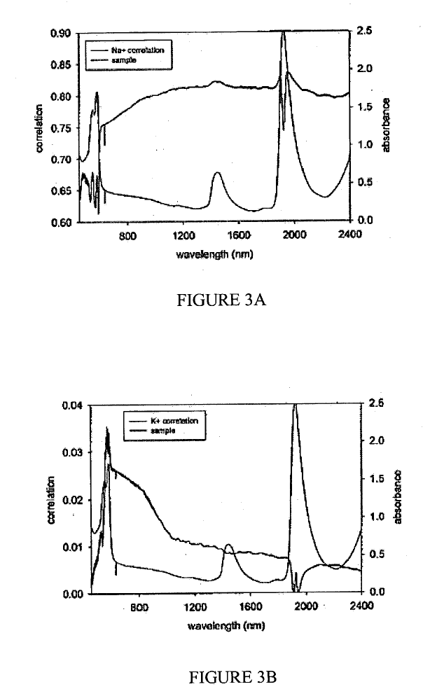

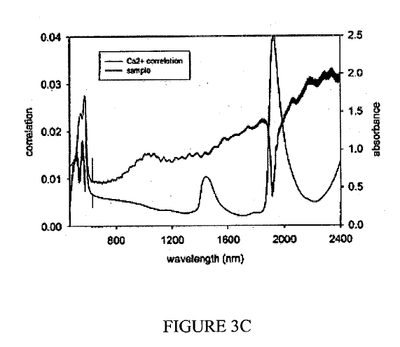

The set of spectra collected for each individual analyte were analyzed to determine the spectral regions that were correlated with concentration of that analyte. These correlation plots are shown in FIGS. 3A, 3B, and 3C. In particular, with reference to FIG. 3A, sodium ion concentration is strongly correlated with the 1924 nm water band and the oxyhemoglobin doublet at 544 and 577 nm. There is also a weaker correlation with the water band at 1444 nm.

With reference to FIG. 3B, potassium ion concentration is most strongly correlated with the 577 nm hemoglobin band and less correlated with the 1924 nm water band. There is little correlation with the 1444 nm water band.

With reference to FIG. 3C, calcium ion concentration is strongly correlated with the 1924 nm water band and the oxyhemoglobin doublet. Interestingly there is a correlation peak at 1040 nm, possibly a correlation with a small water band. These results demonstrate that all the three ions interact sufficiently with both water and hemoglobin to affect the shape of the absorption spectrum.

The wavelength regions of high correlation were utilized to construct partial least-squares (PLS) calibration models for each ion individually. The results from these analyses are presented in Table II below.

TABLE II
PLS results for analytes prepared separately.

| | Wavelength | | | | |
|---|---|---|---|---|---|
| ANAYLYTE | Region (nm) | Factors | R² | CVSEP | Relative Error |
| Whole Blood | | | | | |
| Sodium | 477-710 | 5 | 0.96 | 5 | 3% |
| | 1830-2592 | | | | |
| Potassium | 475-1000 | 5 | 0.87 | 0.6 | 11% |
| Calcium | 800-2585 | 8 | 0.65 | 0.14 | 14% |
| Lysed Blood | | | | | |
| Sodium | 470-610 | 4 | 0.92 | 7 | 5% |
| | 660-2470 | | | | |

Table II shows that there is excellent correlation (R²>0.85) for sodium and potassium and good correlation for calcium. The relative errors for potassium and calcium are between 10% and 15%. The relative error for sodium ion is less than 5% in both the whole blood and lysed blood experiments. Good model results for sodium ion in both whole and lysed blood indicate that the calibration model does not entirely depend upon light scattered from red blood cells whose sizes are correlated with the sodium concentration. If that were the case, accurate sodium model based on lysed blood, in which there are no red blood cells, could not be constructed.

These results indicate that there are spectral changes associated with both the water and hemoglobin bands that permit accurate measurement of electrolyte concentration in whole blood. Since all three ions rely on similar regions of the spectrum, it is important to determine if each analyte concentration can be determined in the presence of the other two.

Aggregate Ion Experiments

In this set of experiments, blood was drawn from a healthy volunteer and divided into 24, 2 ml samples. Each sample was diluted with 1 ml of 5% dextrose in water (D5W) containing ammonium bicarbonate to maintain [HCO₃⁻] near 25 mmol/L. Samples were randomized to varying concentrations of Na⁺, K⁺, and Ca²⁺. The electrolyte concentrations were varied simultaneously. Each sample was tonometered at 37° C. with a mixture of 12% oxygen and 6% carbon dioxide to maintain samples at constant, normal blood gas and pH values. Blood gas, pH and electrolyte concentrations were measured in each sample of the blood, and spectra were acquired in the range of 400-2600 nm.

The values of the physiologic parameters for the aggregate ion experimental samples are provided in Table I presented above. The values of pH, PCO₂, PO₂ and oxygen saturation are all in normal ranges and are well controlled. There is some variation in PO₂, but the oxygen saturation varies very little. Hemoglobin was constant but MCV showed some variability because of the range of sodium ion concentration.

Table III below shows the results of analysis of correlations between the ion concentrations and other parameters that would affect the absorption spectra. None of the electrolyte ion concentrations was correlated with another. Further, no correlation between pH, bicarbonate ion and any of the electrolytes was observed. Only sodium ion concentration was correlated with cell size, as observed in the single ion experiments.

TABLE III
Correlation (R²) between each analyte and other factors that affect
the spectrum

| | [Na⁺] | [K⁺] | [Ca²⁺] | pH | HCO₃ | MCV |
|---|---|---|---|---|---|---|
| [Na⁺] | — | 0.01 | 0.00 | 0.09 | 0.11 | 0.91 |
| [K⁺] | 0.01 | — | 0.00 | 0.02 | 0.02 | 0.01 |
| [Ca²⁺] | 0.00 | 0.00 | — | 0.01 | 0.01 | 0.01 |

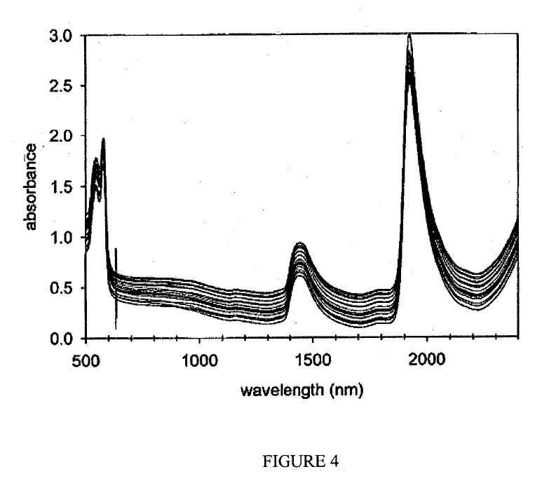

FIG. 4 presents the spectra of those solutions that were utilized for model development. The hemoglobin doublet and two water bands are clearly evident in these spectra. The shift in baseline results from scattering of the red cells. As sodium concentration increases above normal serum levels (˜140 mmol/L), the red cell size shrinks as water leaves the cell to normalize sodium concentration in serum. Similarly, if serum concentration of sodium is less than normal, water enters the red blood cells, causing them to swell. It was shown in the previous section that sodium calibration models can be built independently of cell size changes. No baseline corrections were done to these spectra.

The results for the calibration models for each of the ions are shown in Table IV. The top half of the table shows the results when the entire wavelength region is used. While these results are good, they are slightly degraded from the single analyte results.

TABLE IV
PLS results for analytes prepared together in a single solution.

| | Wavelength | | | | Relative |
|---|---|---|---|---|---|
| Analyte | Region (nm) | Factors | R² | CVSEP | Error |
| Full wavelength range | | | | | |
| Sodium | 470-2450 | 5 | 0.89 | 8 | 7% |
| Potassium | 470-2450 | 5 | 0.60 | 1.4 | 18% |
| Calcium | 470-2450 | 5 | 0.77 | 0.13 | 14% |
| Wavelength selection | | | | | |
| Sodium | 470-610 | 8 | 0.99 | 3 | 2% |
| | 1840-2200 | | | | |
| Potassium | 500-1100 | 10 | 0.89 | 0.6 | 9% |
| | 1840-2200 | | | | |
| Calcium | 500-1100 | 8 | 0.64 | 0.16 | 17% |

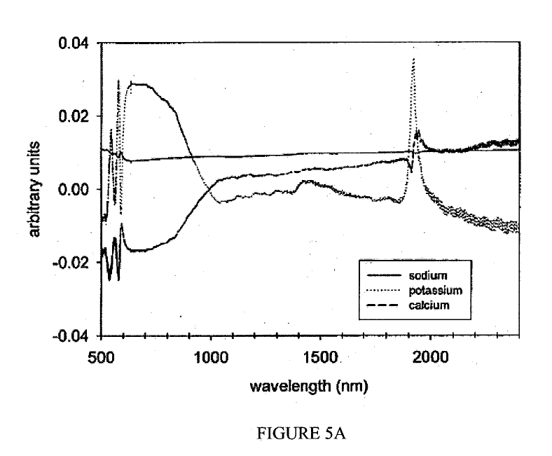

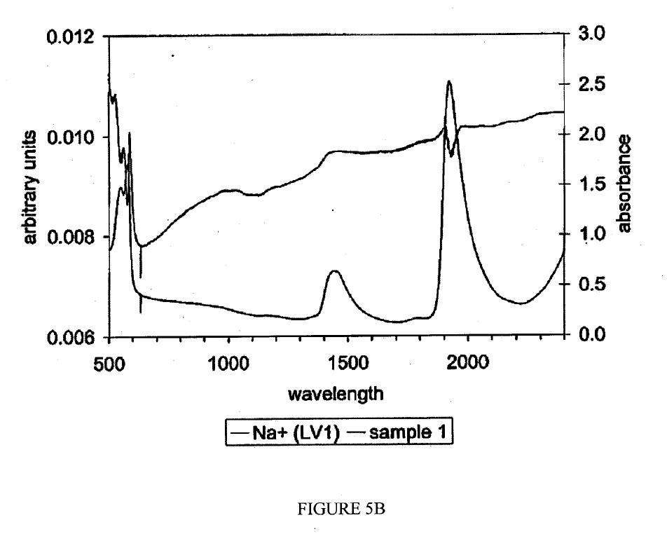

FIG. 5A shows the loading vectors most correlated with analyte concentration for each of the three electrolytes modeled. In general, the number of vectors is determined by a cross-correlation procedure in which a regression analysis is performed against concentration to determine the first vector. The residuals are regressed, and the process is repeated until an optimal number of vectors is determined. In a good model, the first three vectors contain most of the analyte information, and the remaining vectors represent other sample variability not explained by analyte concentration. For sodium, the first loading vector is most correlated with analyte concentration and at first glance looks flat. It is highly likely that this loading vector represents light scattering and baseline shifts that are correlated with sodium concentration. Closer examination of this loading factor reveals some features of both the hemoglobin and water spectra. When enlarged, as shown in FIG. 5B, this loading vector resembles the correlation plot in FIG. 3A.

With continued reference to FIG. 5A, the second loading vectors in both the potassium and calcium models is the one most highly correlated with the respective analyte concentration. Both ions show dependence upon the hemoglobin and water bands, though the dependence is different for both ions. These loading vectors were used to select wavelengths for a new round of model development.

The bottom half of Table IV shows the results when the wavelength region is narrowed. Wavelength selection increases the number of factors, but significantly improves the results for the sodium and potassium models.

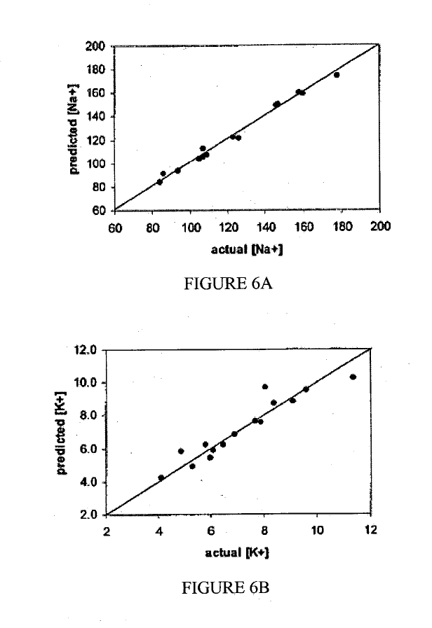

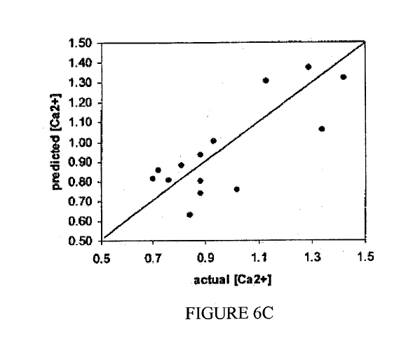

FIGS. 6A, 6B, and 6C illustrate a number of plots comparing the actual and predicted analyte concentrations for each of the above ions, namely, sodium, potassium and calcium ions, respectively. Excellent results were obtained for sodium and potassium, with R² greater than 0.9 and relative error less and 10%.

The results for calcium are not as good as those of the other two analytes. Two factors contribute to the poorer results. One is the low physiologic concentration of calcium ion in blood (0.5-2.7 mmol/L), significantly less than that of potassium (2.0-9.0 mmol/L) and sodium (100-180 mmol/L). Our results indicate that calcium ion concentration does affect the spectrum of hemoglobin and water, but to a lesser extent than the other ions, e.g., sodium and potassium, do. The other contributing factor in the particular experiment reported here was the complexation of the calcium ion with the added bicarbonate ion, making it difficult to create a sample that randomly spanned the region of interest.

Our data show that sodium, potassium, and calcium ions can be measured in whole blood using near infrared spectroscopy. Each ion appears to significantly alter the absorption spectrum of both water and hemoglobin in a way that can be derived by utilizing chemometric analysis. The impact of each ion is significantly different to allow determination of each analyte in the presence of the others.

In one preferred embodiment, calibration models are constructed by utilizing those regions of the spectrum that encompass the hemoglobin and water absorption bands. The inclusion of the hemoglobin absorption bands in the calibration model is a novel finding. The 577 nm and 544 nm bands of oxyhemoglobin correspond to Q(0,0) and Q(0,1) iron d to porphyrin π orbital transitions. Applicants suggest that in the present study the cations, Na⁺, K⁺ and Ca²⁺, are present in sufficient concentration to alter the hydrogen bonding properties of water that is present in the serum and is hydrogen bonded to the hemoglobin iron. Changes in hydrogen bonding of water near the heme iron are sufficient to alter the visible and NIR spectrum of hemoglobin.

Thus, Applicants have also found, as corroborated by the above experimental results, that the concentrations of clinically important electrolytes present in whole blood can be simultaneously measured, in the physiologically relevant concentration ranges, by utilizing light in a wavelength range of about 500 to about 2200 nm which advantageously passes through skin and bone without significant absorption.

### EXAMPLE II

In another series of experiments, concentrations of Na⁺, K⁺, and Ca²⁺ ions were spectroscopically calculated based on models that utilize absorption data in a wavelength range of about 470 nm to 925 nm in which oxyhemoglobin exhibits absorption, but water does not. However, as it is known by those having ordinary skill in the art, in the eye, the vitreous humor, which is mostly water, absorbs most of the light beyond 1000 nm. Hence, calibration equations were developed by employing only the 500-1000 nm region, in other words, by utilizing only the effect of the electrolytes on the hemoglobin spectrum. Applicants were able to achieve equally good calibration results in the visible region as in the combined visible and NIR.

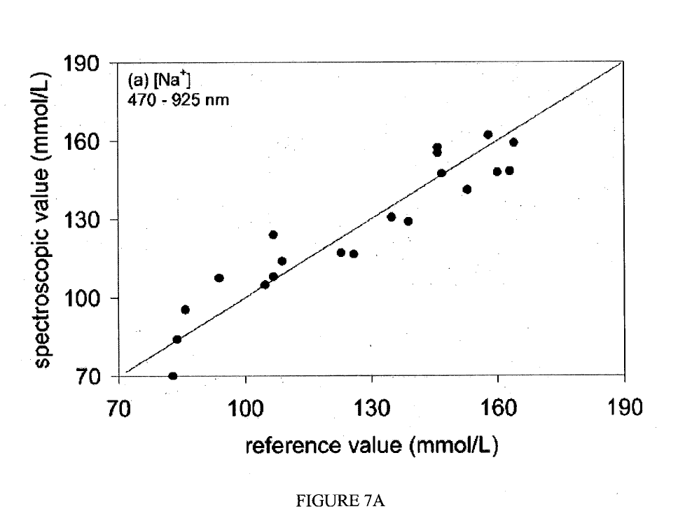

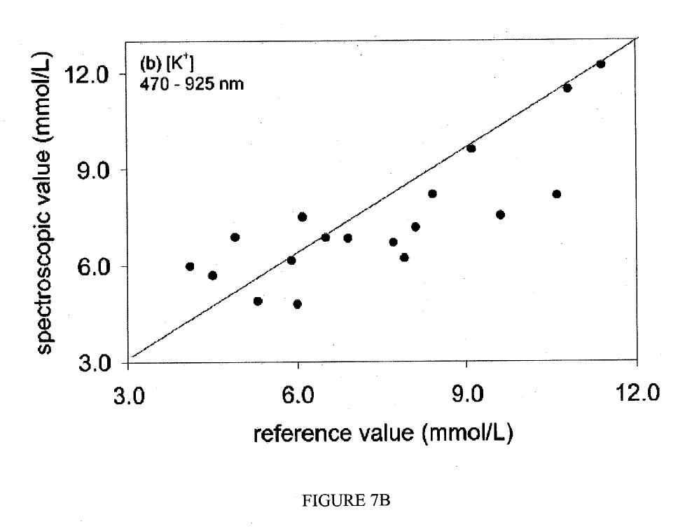

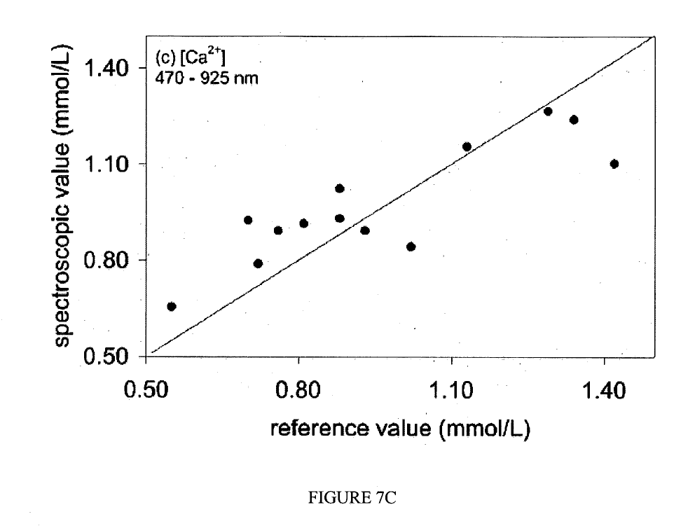

Table V below, and FIGS. 7A-7C, illustrate the results of the spectroscopically calculated concentrations of these three ions. Because of the low concentration of these analytes, especially potassium and calcium, more accurate results can be obtained by acquiring spectra through a subject's eye, where there is minimal interference from tissue scattering and skin pigmentation effects. A co-pening patent application entitled “Ocular Spectrometer and Probe Method for Non-invasive Spectral Measurement,” having Ser. No. 10/086,903, filed on Feb. 28, 2002, and herein incorporated by reference, describes spectroscopic instruments suitable for obtaining such spectra through a subject's eye.

In a separate experiment, Applicants evaluated the measurement of sodium concentration in lysed blood. Changes in sodium concentration are highly correlated with variation in red cell size. We demonstrated good calibration models in lysed blood, indicating that spectroscopic measurement of sodium is not dependent upon light scattering resulting from cell swelling and shrinkage in either the range 470-925 nm or 470-2500 nm.

TABLE V
PLS results for 3 analytes prepared simultaneously in diluted whole blood
for radiation in a range of 470 to 925 nm

| | Data points | | | CVSEP | Relative |
|---|---|---|---|---|---|
| Analyte | in model | Factors | R² | (mmol/L) | error |
| Sodium | 20/23 | 3 | 0.88 | 9.3 | 7% |
| Potassium | 16/23 | 4 | 0.66 | 1.3 | 17% |
| Calcium | 14/23 | 4 | 0.68 | 0.15 | 16% |

These results are comparable in accuracy with concentration results obtained based on models that utilize the full wavelength range of about 475 nm to 2500 nm, while exhibiting a slightly improved trending (R²). These data suggest that ionic interaction with oxyhemoglobin is sufficient to cause spectral shifts that can be modeled by PLS.

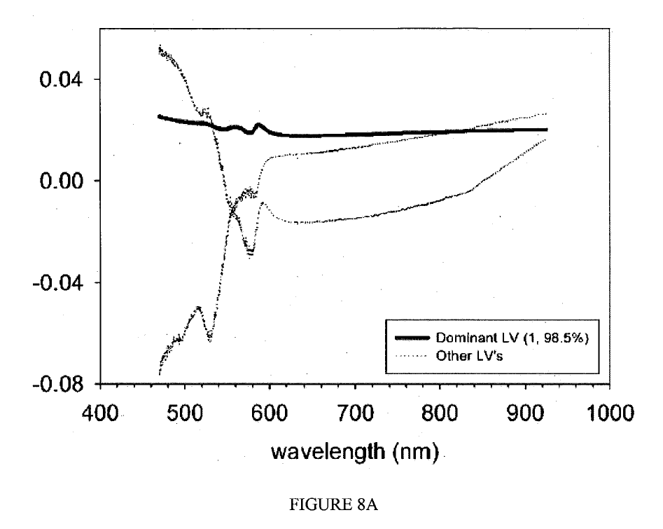

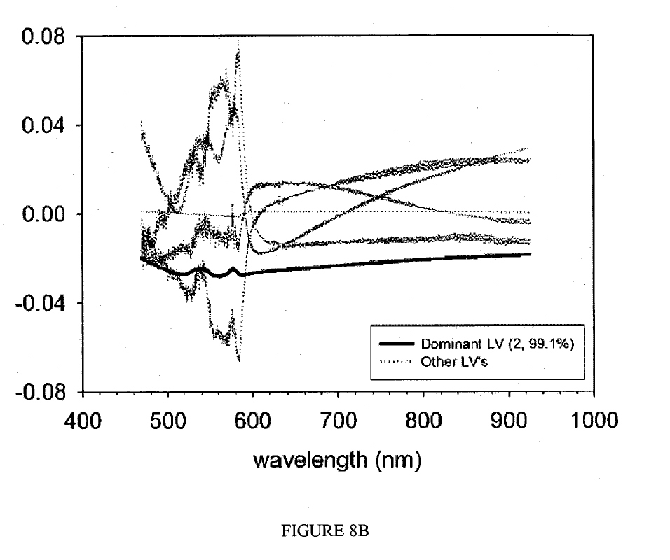

FIG. 8A illustrates a number of loading vectors for Na⁺ ion model in whole blood, containing sodium, potassium and calcium, derived for the wavelength range of 470 nm to 925 nm. FIG. 8B illustrates loading vectors for Na⁺ ion model in lysed blood, with only sodium, also derived for the wavelength range of 470 nm to 925 nm. The predominant loading vectors in the whole blood model and the lysed blood model are similar, and contain spectral features of the oxyhemoglobin doublet. In the whole blood model, the dominant loading vector, depicted in bold, explains 98.5% of spectral variations while in the lysed blood model, the dominant loading vector, also depicted in bold, explains 99.1% of spectral variations.

Thus, sodium, potassium and calcium ion concentrations can be simultaneously measured by utilizing the above teachings of the invention in whole blood based on absorption data in those regions of the electromagnetic spectrum that include both water and oxyhemoglobin absorption bands as well as the visible and near infrared regions in which only hemoglobin exhibits absorption.

Those having ordinary skill in the art will appreciate that various changes can be made to the above embodiments without departing from the scope of the invention.

What is claimed is:

1. A method for non-invasively measuring concentration of an electrolyte of interest in blood, comprising:
obtaining a plurality of calibration spectra from a plurality of calibration subjects having varying blood concentrations of the electrolyte by utilizing light having at least one wavelength component in a pre-defined wavelength range,
generating reference concentration values by measuring concentration of the electrolyte in each calibration subject's blood by utilizing an invasive measurement technique, and
deriving at least one calibration equation for the electrolyte based on said calibration spectra and said reference concentration values.

2. The method of claim 1, further comprising the steps of
obtaining at least one spectrum of a new subject's blood by utilizing the light having said at least one wavelength component,
processing the spectrum of the new subject's blood with the calibration equation to measure a concentration of the electrolyte in the new subject's blood.

3. The method of claim 1, wherein the step of obtaining calibration spectra comprises acquiring the spectra transdermally.

4. The method of claim 1, wherein the step of obtaining calibration spectra comprises acquiring the spectra from eyes of the calibration subjects.

5. The method of claim 1, wherein the electrolyte of interest is any of a sodium ion, a calcium ion and a potassium ion.

6. The method of claim 1, further comprising selecting the pre-defined wavelength range to be from about 400 nm to about 2000 nm.

7. The method of claim 1, further comprising selecting the pre-defined wavelength range to be from about 1800 nm to about 2200 nm.

8. The method of claim 1, further comprising selecting the pre-defined wavelength range to be from about 475 nm to about 1000 nm,

9. The method of claim 1, further comprising selecting the pre-defined wavelength range to be from about 1830 nm to about 2600 nm.

10. The method of claim 1, further comprising selecting the pre-defined wavelength range to be from about 2000 nm to about 2585 nm.

11. The method of claim 8, further comprising selecting the electrolyte to be sodium ion.

12. The method of claim 9, further comprising selecting the electrolyte to be potassium ion.

13. The method of claim 10, further comprising selecting the electrolyte to be calcium ion.

14. The method of claim 1, further comprising selecting the pre-defined wavelength range to be from about 470 nm to about 925 nm.

15. The method of 14, further comprising selecting the electrolyte to be any of sodium, potassium or calcium ion.

16. The method of claim 1, wherein the step of deriving a calibration equation further comprises utilizing a multivariate calibration technique.

17. The method of claim 14, wherein said multivariate calibration technique employs a partial least squares regression.

18. A method for non-invasive measurement of concentration of an electrolyte of interest in blood, comprising the steps of:
collecting one or more spectra of one or more blood samples having variable electrolyte concentrations by utilizing light having at least one wavelength in a selected wavelength range,
measuring electrolyte concentration of each of said blood samples by utilizing an invasive measurement technique,
augmenting the collected spectra with one or more human variability factors, and
deriving a calibration equation corresponding to the electrolyte of interest based on said augmented calibration spectra and said measured electrolyte concentrations.

19. The method of claim 18, wherein the step of deriving a calibration equation further comprises utilizing a multivariate calibration technique.

20. The method of claim 19, wherein said multivariate calibration technique employs a partial least squares regression.

21. The method of claim 18, wherein said human variability factors can be any of skin color, fat content or a disease stage.

22. The method of claim 18, further comprising selecting the wavelength range to be from about 1800 nm to about 2200 nm.

23. The method of claim 18, further comprising selecting the wavelength range to be from about 475 nm to about 1000 nm.

24. The method of claim 18, further comprising selecting the wavelength range to be from about 1830 nm to about 2600 nm.

25. The method of claim 18, further comprising selecting the wavelength range to be from about 470 nm to about 925 nm.

26. The method of claim 18, further comprising the step of collecting one or more spectra of a subject's blood by utilizing the light having said at least one wavelength.

27. The method of claim 18, further comprising processing one or more spectra of the subject's blood by utilizing the calibration equation to obtain a measurement of the electrolyte concentration in the subject's blood.
